(19) United States
(12) Patent Application Publication
(10) Pub. No.: US 2007/0122574 A1
(43) Pub. Date: May 31, 2007

(54) STORAGE ELEMENT FOR TOOLS

(75) Inventor: Daniel P. Brown, Palos Park, IL (US)

Correspondence Address: VEDDER PRICE KAUFMAN & KAMMHOLZ, 222 N. LASALLE STREET, CHICAGO, IL, 60601, US

(73) Assignee: LOGGERHEAD TOOLS LLC, Palos Park, IL (US)

(21) Appl. No.: 11/668,980

(22) Filed: Jan. 30, 2007

Related U.S. Application Data
(63) Continuation-in-part of application No. 11/279,370, filed on Apr. 11, 2006.
Application No. 11/279,370 is a continuation-in-part of application No. 11/102,966, filed on Apr. 11, 2005.
Application No. 11/102,966 is a continuation-in-part of application No. 10/763,489, filed on Jan. 23, 2004, now Pat. No. 6,889,579.

(51) Int. Cl. B31B 45/00

(52) U.S. Cl. 428/34.1

(57) ABSTRACT

This disclosure pertains to a storage element, and more particularly, to a storage element that stores and retains work elements in a high-density configuration. This disclosure also pertains to work elements, and more particularly, to a double-ended work element that is compatible with tools as are conventional work elements and the storage element described herein.

### RELATED APPLICATIONS

This application is a continuation-in-part of and claims the benefit of and priority from U.S. patent application Ser. No. 11/279,370, filed Apr. 11, 2006, which is a continuation-in-part of and claims the benefit and priority from U.S. patent application Ser. No. 11/102,966, filed Apr. 11, 2005, which is a continuation-in-part of and claims the benefit of and priority from U.S. patent application Ser. No. 10/763,489, filed Jan. 23, 2004, now issued as U.S. Pat. No. 6,888,579, each of which is expressly incorporated herein by reference.

### BACKGROUND

This disclosure pertains to a storage element, and more particularly, to a storage element that stores and retains work elements in a high-density configuration. This disclosure also pertains to work elements and more particularly, to a double-ended work element that is compatible with tools as are conventional work elements and the storage element described herein.

Various types of storage elements for work elements are known in the art. However, each of the prior art devices has disadvantages. Most notably, prior art storage elements have structural and functional configurations that do not facilitate adequate retention of the work elements. Additionally, prior art storage elements cannot be installed in more than one different tool.

Various types of double-ended bits are know in the art. However, such prior art devices have disadvantages. Most notably, the structural configuration of such prior art bits prevent compact storage and transportation in a high density configuration. Additionally, none is compatible with a storage element that can be disposed in an opening of a tool. Moreover, none has positive retention features defined thereon for interface with a complementary structure on a storage element. Prior art double-ended bits all have a length greater than 1.25 inches because existing tooling prevents manufacture of shorter bits.

Therefore, there exists a need in the art for a storage element and double-ended work element that overcomes the disadvantages of the prior art.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 is a partially exploded perspective view of an embodiment of a tool including a storage element in accordance with the principal aspects of the present disclosure.

FIG. 2 is a partially exploded view of a portion of the adjustable gripping tool of FIG. 1.

FIG. 3 is a top perspective view of an embodiment of the storage element of FIG. 1 with a locking portion.

FIG. 4 is a top perspective view of an embodiment of the storage element of FIG. 1 with a projection.

FIG. 5 is a side perspective view of the storage element of FIG. 4 with various work elements.

FIG. 6 is a sectional front view taken along the line 6-6 as shown in FIG. 5.

FIG. 7 is a front elevation of an embodiment of a work element as inserted in the storage element of FIG. 5.

FIG. 8 is a side perspective view of a storage element according to an embodiment of the present disclosure with various work elements.

FIG. 9 is a front element of another embodiment of a work element as inserted in the storage element shown in FIG. 8.

FIG. 10 is a top view taken along the line 10-10 as shown in FIG. 9.

FIG. 11 is a top perspective view of an embodiment of the storage element with notches.

FIG. 12 is a partial top perspective view of an embodiment of the storage element with a tabbed locking element.

FIG. 13 is a side perspective view of the storage element as shown in FIG. 11 of the present disclosure with various work elements.

FIG. 14 is a partially exploded perspective view of an embodiment of a tool including a storage element in accordance with the another aspects of the present disclosure.

FIG. 15 is a partially exploded view of a portion of the adjustable gripping tool of FIG. 14.

### DETAILED DESCRIPTION

For the purposes of promoting and understanding the principles disclosed herein, reference will now be made to the preferred embodiments illustrated in the drawings and specific language will be used to describe the same. It will nevertheless be understood that no limitation of the scope is thereby intended. Such alterations and further modifications in the illustrated device and such further applications are the principles disclosed as illustrated therein as being contemplated as would normally occur to one skilled in the art to which this disclosure relates.

One principal aspect of the present disclosure is directed to a storage element that includes opposed sides and ends, a top, and a bottom. Receptacles are defined by an interior surface and an interior wall defined between adjacent receptacles. A locking element is disposed on the interior surface for selectively retaining a work element.

Another principal aspect of the present disclosure is directed to a work element having a length less than 1.25 inches, a center portion including a drive contour, and an engaging portion formed at opposing ends of the center portion.

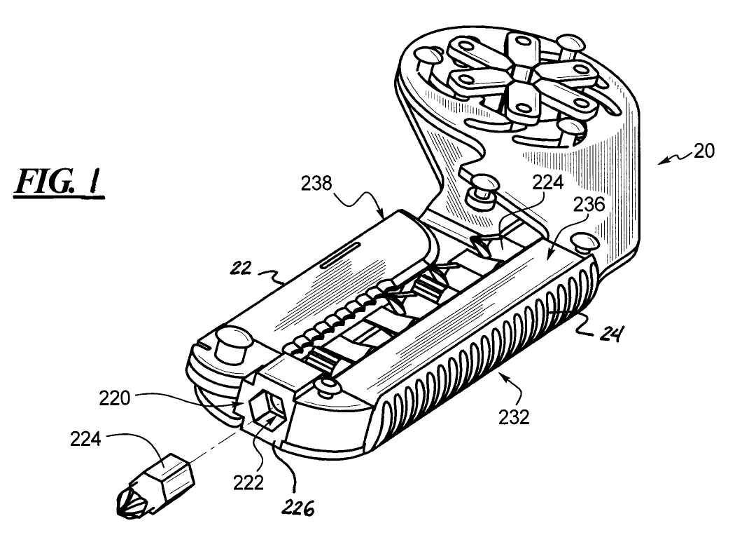

FIG. 1 illustrates in a partially exploded perspective view the adjustable gripping tool 20 in accordance with one of the principal aspects of the present disclosure. In this embodiment, the adjustable gripping tool 20 includes an end piece 220 connected to one of the first and second elements 22, 24 and having a receptacle 222 defined therein configured to removably engage one of a plurality of work elements 224. Preferably, the receptacle 222 is formed in an outer surface 226 of the end piece 220. It is within the teachings of the present disclosure that the end piece 220 may also frictionally or otherwise engage the other of the first and second elements 22, 24 of which the end piece 220 is not connected so as to maintain the first and second elements 22, 24 in the closed or second operative position.

In another embodiment, a storage element 228 is moveably connected to at least one of the first and second elements 22, 24 and may be connected to each. The plurality of work elements 224 are configured to removably engage the storage element 228 in any suitable manner. It is within the teachings of the present disclosure that the storage element 228 have a plurality of receptacles 230 defined therein, each configured to removably engage one of the plurality of work elements 224. Alternatively, the storage element 228 may be configured with a substantial channel shape that retains the work elements 224 therein by any suitable or conventional manner, for example, frictionally engaging, magnetically retaining, adhesively retaining, or using any other suitable means to retain the work elements 224 within the storage element 228. Further alternatively, the at least one of the first and second elements 22, 24 may be magnetized to retain the work elements 224. Accordingly, one of skill in the art will recognize that the material of construction for the storage element 228 may be selected from the group consisting of rubber, plastic, metal, composite, or any other suitable material.

Preferably, a textured surface 232 is formed on an outer surface 234 of the storage element 228. It is within the teachings of the present disclosure that the textured surface 232 may be integrally or separably formed with respect to the storage element 228 and may be constructed of any suitable material. However, it has been found that a deformable material provides an ergonomic advantage.

In one embodiment, the storage element 228 is movably connected to at least one of the first and second elements 22, 24. It is within the teachings of the present disclosure that such movable connection may be selected from the group consisting of a lateral friction fit, wherein the storage element 228 may be moved laterally with respect to its longitudinal axis, a pivoting friction fit, wherein the storage element 228 is pivotally connected at one of its ends 236 to one of the first and second elements 22, 24, or any other suitable connection that permits movement of the storage element 228 to provide access to the work elements 224. It will be recognized by one of skill in the art that the pivoting friction fit provides certain advantages, in that, the storage element 228 is never entirely disconnected from the adjustable gripping tool 20. However, one of skill in the art will also recognize that maximum density of storage for the plurality of work elements 224 is provided when configured with a lateral friction fit.

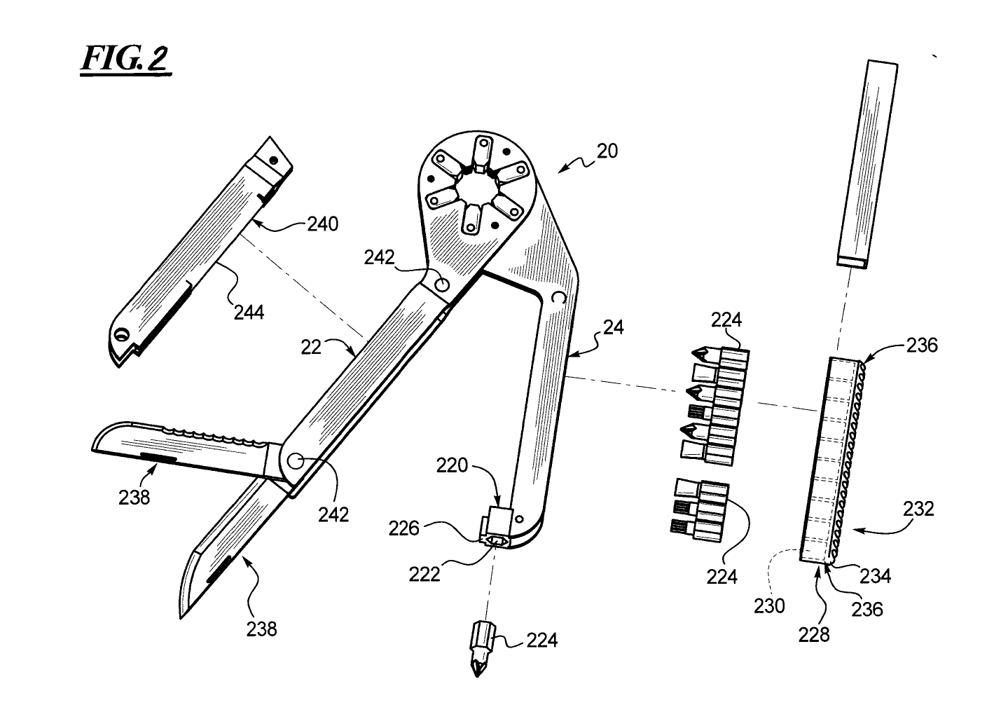

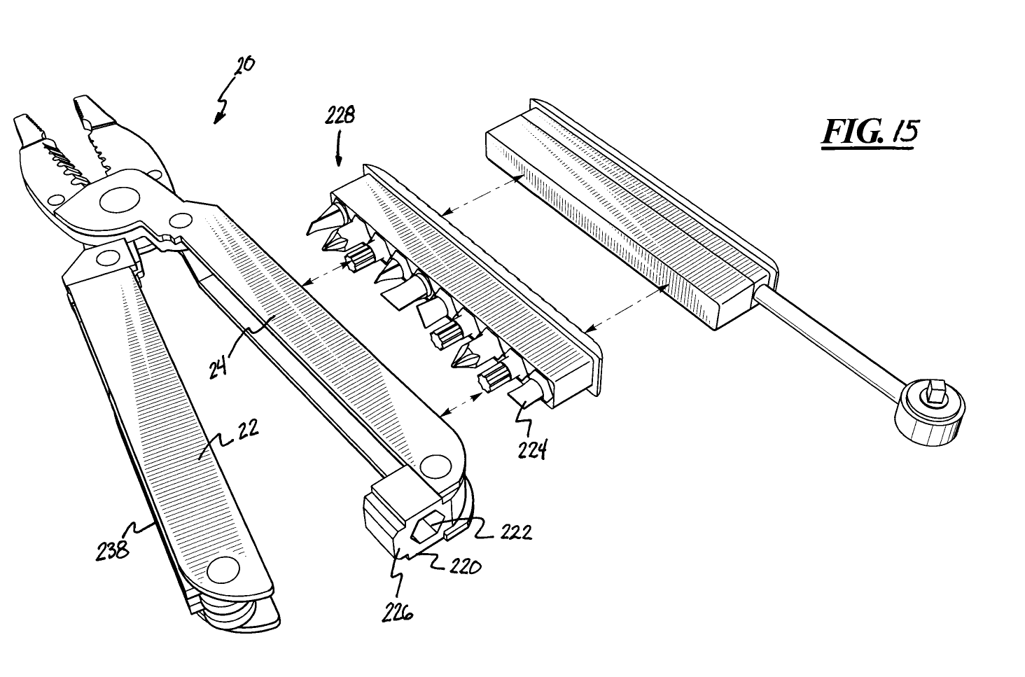

In another embodiment, at least one tool 238 is pivotally connected to one of the first and second elements 22, 24 opposite the end piece 220. Each at least one tool 238 is disposed within the one of the first and second elements 22, 24 opposite the end piece 220 in a stored orientation, as shown in FIG. 1, and is moveable to an open orientation as shown in FIG. 2. Another embodiment of the adjustable gripping tool 20 is shown in FIG. 14 in a stored orientation and is moveable to an open orientation as shown in FIG. 15. Preferably, each at least one tool 238 is independently movable between the stored orientation and the open or operative orientation wherein such tool extends from the one of the first and second elements 22, 24 opposite the end piece in order to provide its intended function. It is within the teachings of the present disclosure that the tool 238 may have any suitable configuration. For example, the tool 238 may be configured as a knife, saw, screwdriver, pliers, awl, corkscrew, scissors, can opener, bottle opener, file, punch, clipper, reamer, hook, wire cutter, scale, or any other suitable tool. An insert 240 may also be disposed associated with the first element 22 and each of the tools 238. Preferably, the insert 240 is connected to the first element 22 with existing fasteners 242. However, it is within the teachings of the present disclosure that the insert 240 may be connected to the first element 22 in any other suitable manner. The bottom surface 244 of the insert 240 prevents a user from contacting the tools 238 when grasping the first element 22. The remaining structural and functional elements and aspects of any embodiment described with respect to FIGS. 1-2 and 14-15 of the present disclosure may be configured as any of the like structural and functional aspects to the other embodiments of the prior applications incorporated herein by reference.

FIG. 2 is a partially exploded detailed view of a portion of the adjustable gripping tool of FIG. 1. By association with a related embodiment, all of the detailed description, when applicable, relates to the embodiment shown as FIGS. 14-15. In this embodiment of the present disclosure, the receptacle 222 is configured complementarily to the work elements 224 such that the work elements 224 are snugly received within the receptacle 222 so that the tool 20 may be manipulated to cause the work elements 224 to function as intended. It is within the teachings of the present disclosure that the receptacle 222 may be configured to retain the work elements 224 therein by any conventional manner. For example, the work elements 224 may be retained within the receptacle 222 frictionally, magnetically, adhesively, or in any other suitable manner. Additionally, mechanical means to secure the work element 224 within the receptacle may be provided. The remaining structural and functional elements and aspects of this embodiment of the present disclosure may be configured as any of the like structural and functional aspects of the other embodiments disclosed herein.

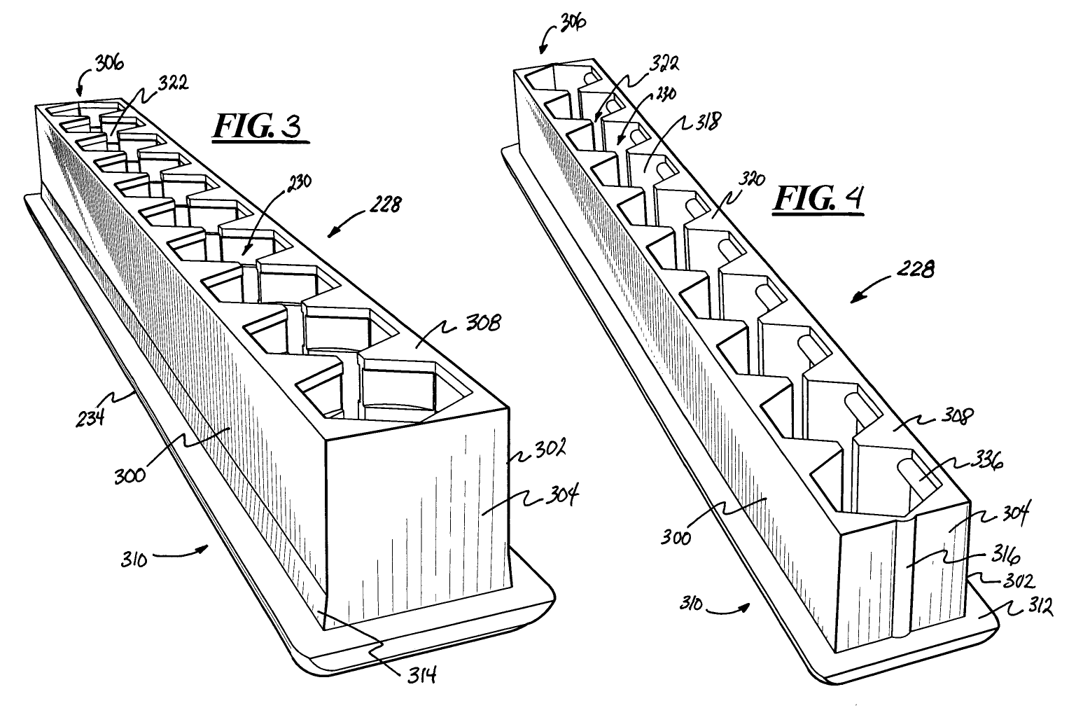

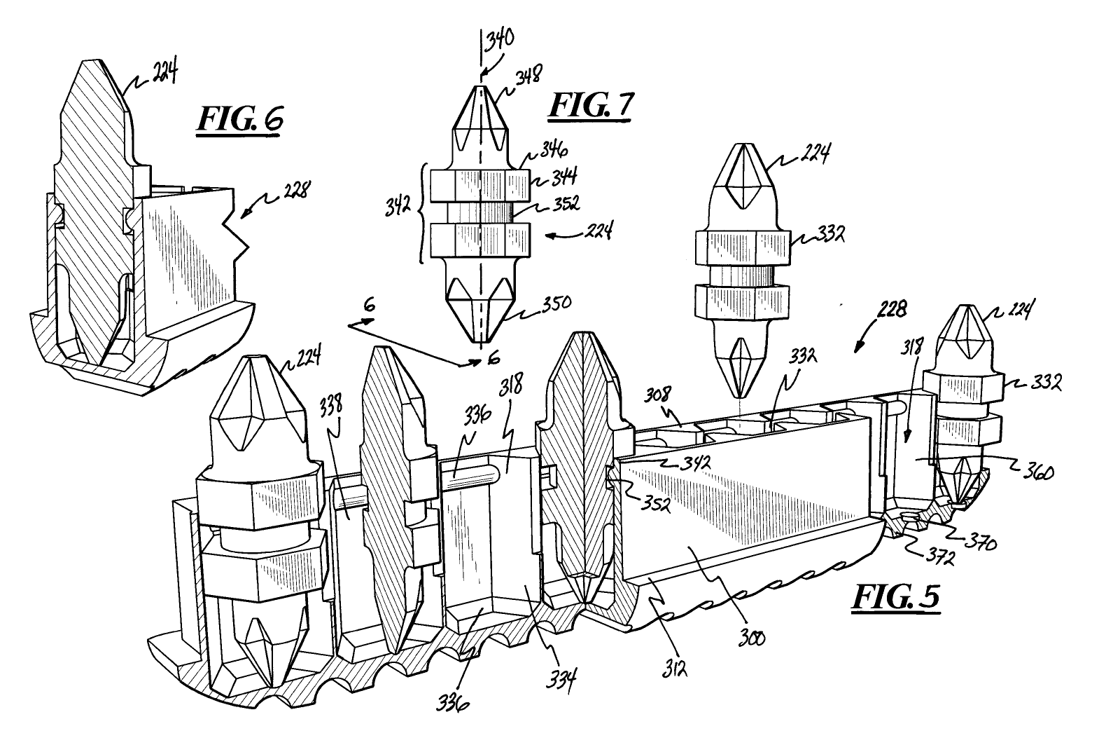

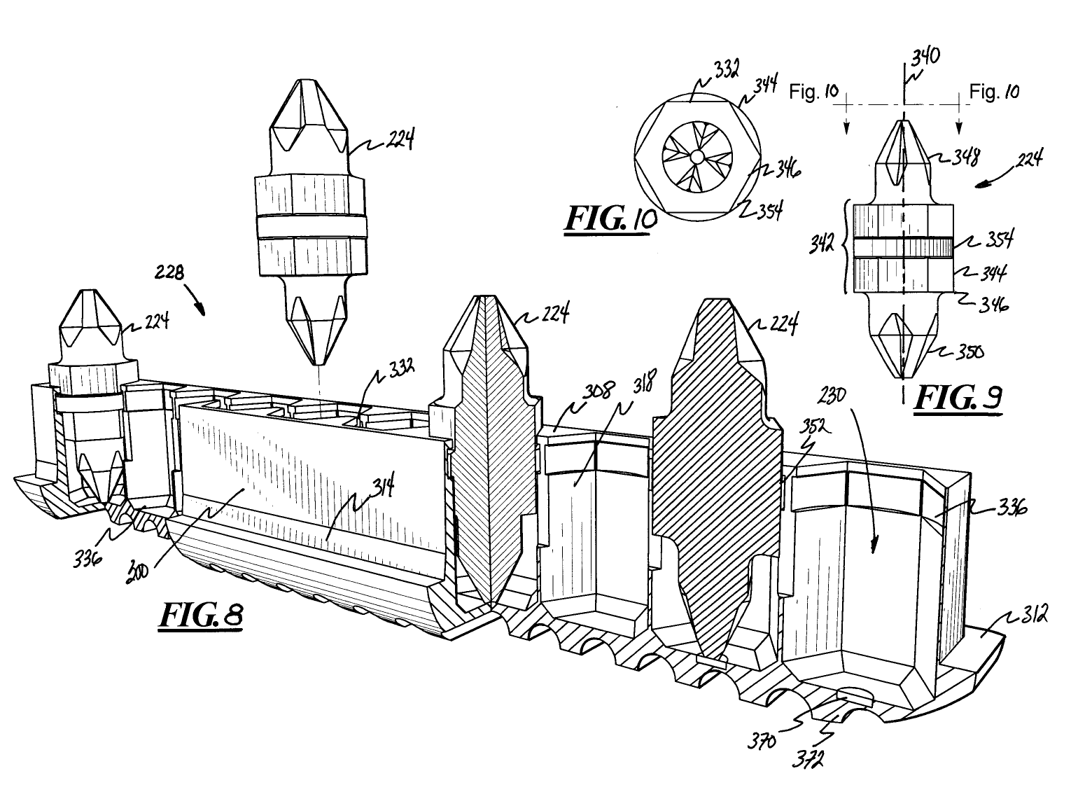

FIG. 3 is a top perspective view of an embodiment of a storage element 228 in accordance with the principle aspects of the present disclosure. Other embodiments of the storage element 228 has been described above more generally and will be described hereinafter with more particularity. Similar to the storage element described above, this embodiment of the storage element 228 includes opposed sides 300, 302, opposed ends 304, 306, a top 308, and a bottom 310. As described above, the bottom 310 or outer surface (234 described above) may have a textured surface 232 formed therein or disposed thereon. The bottom 310 is generally defined by a shoulder portion 312 and the outer surface 234 that extends away from the shoulder portion 312 generally in a common direction to define the textured surface 232 in this embodiment.

A locking portion 314 is disposed and/or defined adjacent the bottom 310 generally along the shoulder portion 312 on at least one of the opposed sides 300, 302. Preferably, the locking portion 314 is formed on both opposing sides 300, 302 and extends downwards towards the shoulder portion 312 with a desired taper having a draft angle of approximately 0 degrees to 5 degrees.

FIG. 4 shows one embodiment where a projection 316 may be formed, disposed, and/or defined on at least one of the ends 304, 306, preferably on each of the ends 304, 306. Such projection 316 enables the storage element 228 to be configured with a very high density of storage for work elements. What is shown in FIG. 3 and 4 are two different embodiments with a projection 316 and a locking portion 314 placed upon different storage elements 228, but the embodiment where both the projection 316 and the locking portion 314 are located on the same storage element 228 is also contemplated. The projection 316 also provides an additional function similar to the locking portion 314 to secure the storage element 228 in a desired compartment. What is shown and contemplated is the use of matter, placed on the external surface of the storage element 228, to enhance locally the friction between the storage element 228 and any location where the storage element 228 is inserted.

A plurality of receptacles 230 are defined in the storage element 228 each by an interior surface 318 extending from the top 308 toward the bottom 310. An interior wall 320 is defined between adjacent receptacles 230. It is within the teachings of the present disclosure that the interior wall 320 may be configured in any suitable manner, shape, or size. For example, the interior surface 318 may be defined by a plurality of planer portions, a single surface without corners, a generally cylindrical configuration, or any other suitable or desirable configuration. A slot 322 may be formed in at least one interior wall 320, thereby forming a channel, opening, or passageway between the adjacent receptacles 230.

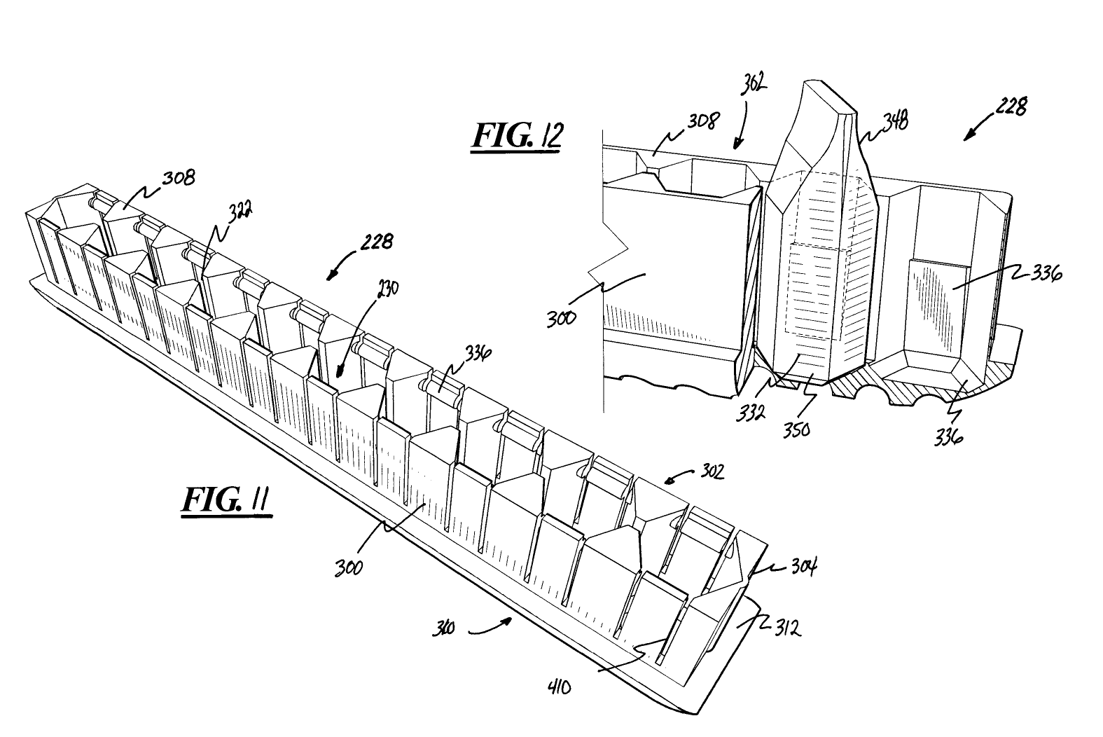

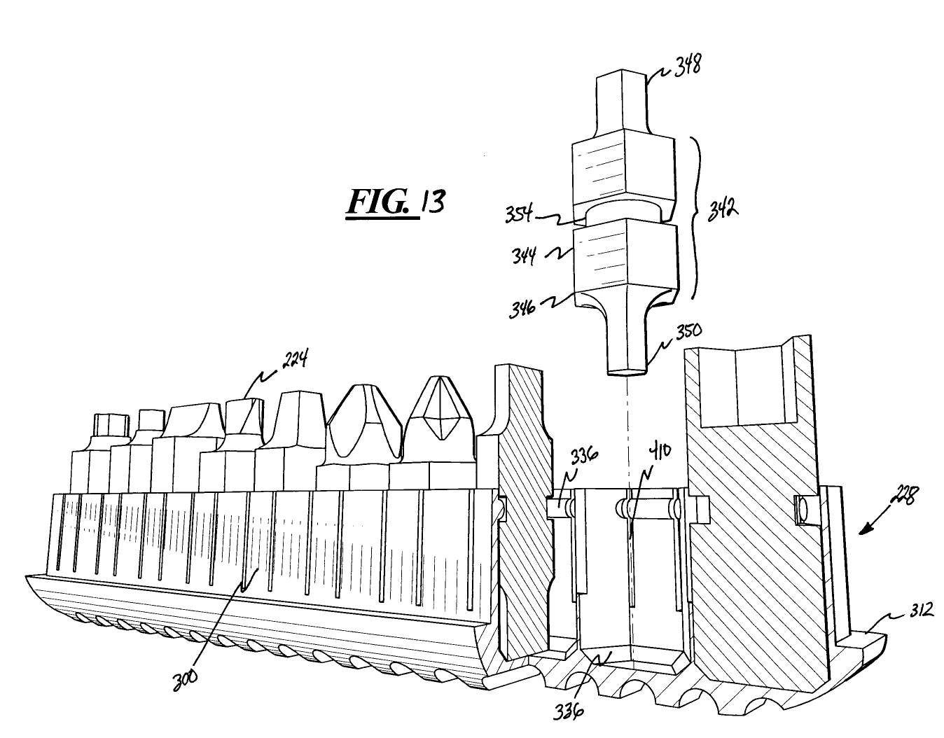

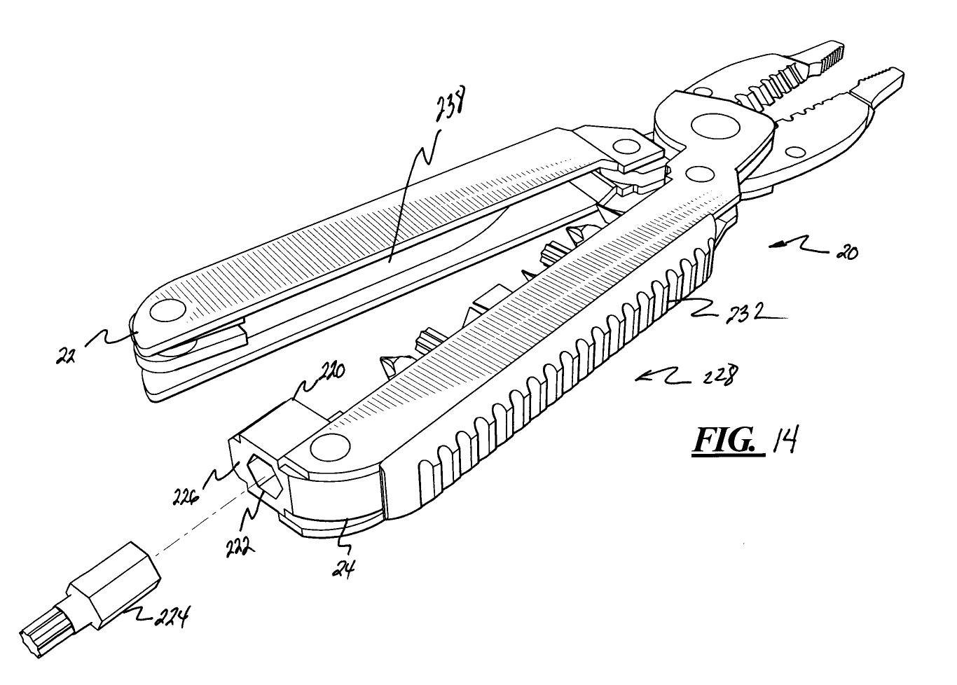

FIG. 5 is a side perspective view of the storage element 228 as shown in FIG. 4 showing various work elements 224 disposed in individual receptacles 230. What is shown is a series of work elements 224 having a conventional hexagonally shaped main body portion 332 retained in each of their respective receptacles 230 by a first locking element 336. Adjacent receptacle 230, which does not have a work element 224 disposed therein, will be used for explanation of such first locking element 336. These receptacles 230 are defined by an interior surface 318 defined by a plurality of planar portions 334 arranged to form a contour of a shape analog to the shape of the work element 224. What is shown is the use of hexagonally shaped work elements 224 and six planar portions 334 forming a hexagonal receptacle 230. What is also contemplated is the use of any regular shape, such as a circle, a pentagon, or any other geometry, that may be associated with the shape of the work element 224. In this embodiment, a first locking element 336 is formed in a upper portion 338 other receptacle 230. It is within the teachings of the present disclosure that the upper portion 338 will be generally recognized as that portion of the receptacle 230 that is closer to the top 308 than to the bottom 310. In one embodiment as shown in FIGS. 4-5, the locking element 336 is a semicircular ridge of such a complimentary geometry to interlock in the work element 224. In another embodiment as shown in FIG. 8, the locking element 336 is a flat notch of sufficient thickness to encase a flat ridge made in another work element 224 according to another embodiment. In yet another embodiment shown in FIG. 12, the locking element 336 is a tab attached to the planar portions 334 on both the portions adjacent to the opposed sides 300, 302. What is contemplated is the use of the tab shown in FIG. 12 as a gradual constraining section for a work element 224 being inserted in the receptacle 230. FIGS. 11 and 13 illustrate yet another possible embodiment where the locking element 336 of a similar geometry as the locking element 336 as shown in FIG. 5 but placed in a receptacle 230 having vertical notches 410.

What is also contemplated is the use of a locking element 336 as a taper that may be defined by a draft angle of approximately 0 degrees to 5 degrees located at the bottom of each receptacles 230. The locking element 336 may be formed on at least one of the planer portions 334, or in the event the interior surface 318 does not include any planer portions, the first locking element 336 may be formed, defined, and/or disposed at any discrete position on the interior surface 318 or entirely about the circumference of the interior surface 318 in the portion 338. It will be recognized by those of skill in the art that different work elements 224 may require different first locking element configurations thus interpretation of the first locking element 336 shall not be construed restrictively. Rather, a first locking element 336 shall be construed as any like reduction in cross section of the receptacle 230 that generally provides a friction or press fit for the work element 224 to retain the work element 224 in the storage element 228.

FIG. 6 is a sectional front view taken along the line 6-6 of FIG. 5 that more clearly illustrates the first locking element 336 formed, defined, and/or disposed in the receptacle 230.

FIG. 7 illustrate a front elevation of an embodiment of a work element 224 in accordance with the principle aspects of this disclosure. FIG. 9 illustrates another front elevation of another embodiment of a work element 224 in accordance with the principle of this disclosure. Each embodiment is directed to a double-ended work element 224. Each work element 224 includes a length along a longitudinal axis 340 that is preferably less than 1.25 inches and in another embodiment no more than one inch in length. Each work element 224 has a center portion 342 including an outer surface 344 having a drive contour 346 defined thereon. It will be recognized by those of skill in the art that the drive contour 346 on the work elements 224 and FIGS. 7 and 9 is a standard hexagonally shaped drive contour and that any other suitable drive contour such as grooves and ridges, planer surfaces, alternating peaks and valleys, alternating male and female elements, a plurality of splines, a cylindrical surface, or any other suitably configured drive contour may be used. An engaging portion 348, 350 is formed, disposed, and/or defined on each opposing end of the center portion 342. It will be recognized by those of skill in the art that the engaging portions 348, 350 may have any suitable configuration and may be configured differently from one another.

In one embodiment, as shown in FIG. 7, a channel 352 is defined and/or formed in the center portion 342. It is within the teachings of the present disclosure that the channel may be formed on only a portion of the center portion 342, for example, on one face if the drive contour includes a plurality of faces, or the channel may extend around the center portion 342 as shown in FIG. 7. It will be recognized by one of skill in the art, in view of the further description below, that only a segment or portion of the channel 352 is necessary to perform the intended function and that a channel extending entirely around the circumference of the center portion 342 may likewise be desirable for an intended function, but is not necessary.

In the embodiment shown in FIG. 9, a protrusion 354 is defined, formed, and/or disposed in the center portion 342 and is useful in connection with the functions more fully described below. In FIG. 9, the protrusion extends around the perimeter of the center portion 342. However, one of skill in the art will recognize that the protrusion may be formed in at least one of a plurality of planer surfaces that define the drive contour or any other suitable configuration, such as, a raised segment on a spline or ridge that defines a drive contour. Furthermore, it is within the teachings of the present disclosure that only a portion of the protrusion may be used if desired and that a protrusion that extends around the perimeter of the center portion 342 is not required.

Returning to FIG. 5, the storage element 228 further retains a work element 224 similar to that described in FIG. 7 at a locked end of the storage element 228. In this embodiment, the receptacle 230 includes a locking element 336 in a form of a protrusion formed in an upper portion 360 of the receptacle 230. The protrusion or locking element 336 is configured to engage the channel 352 formed in the center portion 342 of the work element 224. Thereby, the work element 224 is retained within the receptacle 230. It is within the teachings of the present disclosure that the locking element or protrusion 336 may be disposed, formed, or defined about the perimeter of the interior surface 318. However, it is not required that the protrusion or locking element 336 be so configured. Rather, the protrusion 336 may be formed on only a portion of the interior surface 318 as desired to perform the intended retaining function. As shown in FIG. 5, the protrusion may be disposed, formed, and/or defined on the interior surface other than adjacent the interior wall. In other words, when the receptacle 230 is defined with a plurality of planer surfaces 334, the protrusion may be disposed, formed, and/or defined on those planer surfaces parallel to the opposing sides 300, 302. In one embodiment, the protrusion or locking element 336 is disposed adjacent the slot 322 in the interior wall 320. It is within the teachings of the present disclosure that the slot 322 facilitates flexing of the upper portion 360 of the receptacle sufficient to permit the work element 224 to be inserted therein without sizable resistance. This is particularly advantageous over prior art designs.

In the intermediate portion of the storage element 228 illustrated in FIG. 5, another cut-away section illustrates the work element 224 as shown and described in FIG. 7 retained in a receptacle to 230. The locking element 336 is defined as a channel formed in an upper portion 360 of the receptacle 230. As mentioned above, it is within the teaching of the present invention that the channel 336 may be disposed about the interior surface 318. However, the channel or locking element 336 may also be disposed merely on a portion of the interior surface. For example, the channel or locking element 336 may be disposed on the interior surface 318 other than adjacent to the interior wall 320. In other words, as described above, the channel may be disposed on those surfaces of the interior surface 318 that do not comprise any portion of the interior wall 320. In one embodiment where the interior surface is defined by a plurality of planer surfaces, the channel or locking element 336 may be disposed on those planer surfaces parallel to the opposing sides 300, 302. The channel or locking element 336 may also be disposed adjacent the slot 322 in the interior wall 320 for the advantages described above.

In another embodiment as shown in FIG. 5, the receptacles 230 of the storage element 228 may include a second locking element 370 for selectively retaining the work elements 224 within each receptacle 230. In one embodiment, the second locking element 370 may be disposed, formed, or defined in a floor 372 of the receptacle 230.

It is within the teachings of the present disclosure that the second locking element 370 may be any suitable device to perform the intended function. For example, a second locking element 370 may be selected from the group consisting of a magnet, adhesive, a cut-out portion, deformable polymer, or any other suitable structure to perform a locking function.

FIG. 8 shows the storage element 228 according to another embodiment of the present disclosure that retains a series of work element 224 similar to that shown in FIG. 9. FIG. 10 is a top view of the work element 224 to better illustrate the protrusion 354 located on the work element 224.

What is also disclosed is a method of using a storage element 228 with a plurality of tools 20 consisting of a plurality of consecutive steps. In use, the storage element 228 as described in detail above may be loaded with a plurality of work elements 224 that will provide the anticipated functions of an operator. As one of skill in the art will recognize from above each of the work elements 224 is loaded into an individual corresponding receptacle 230 and preferably the drive contour 346 on each work element 224 is complimentary to the interior surface 318 of the receptacle 230. When loading the work elements 224 into the storage element 228, the operator inserts the work elements 224 until they are selectively retained in position by a first locking element as described in more detail above. Thereafter, the loaded storage element 228 is installed in an opening defined in a first tool 20 that is configured to complimentarily engage the storage element 228. In one embodiment, the storage element 228 is a press fit into such opening. In order to accomplish the press fit, the storage element 228 preferably includes a locking portion disposed on at least one of the opposing sides, which may be, in one embodiment, as described above a taper 314 formed at the intersection of the opposing walls or wall 300, 302 and the shoulder 312. Accordingly, when installing the storage element 228 in the first tool 20, the opposing sides 300, 302 and opposing ends 304, 306 are generally a line of registration with the opening and inserted therein until the locking portion engages the opening. Thereafter, additional force provided by the operator will then press fit the storage element 228 into the opening.

After the intended functions are performed with the first tool 20, the storage element 228 may be removed from the opening of the first tool 20. In order to do so, the locking portion must first be in disengaged before removing the storage element 228. The locking portion may also include a projection 316 disposed on at least one of the opposed ends 304, 306. Such projection 316 will further enhance the ability to achieve a press fit into the opening of the desired tool such that the storage element 228 will not be removed unintended. After the storage element 228 has been removed from the first tool 20, the storage element 228 may then be installed in the opening of a second tool. It is within the teachings of the present disclosure that any number of plurality of tools having an opening configured to complimentarily engage the storage element 228 may be used in connection with such storage element 228.

This disclosure is not limited to the details of the apparatus depicted, and other modification and applications may be contemplated. For example, the size, shape, and position of the structural and functional aspects may be altered as desired to suit particular applications. Further, the elements of the various embodiments described above may be formed from any suitable material, including without limitation metal, plastic, composite, natural, synthetic, or any other material. Certain other changes may be made in the above-described apparatus without departing from true spirit and scope of the disclosure here involved. It is intended, therefor that the subject matter of the above depiction shall be interpreted as illustrated and not in a limiting sense. The actual scope of the disclosure is intended to be defined in the following claims when viewed in their proper perspective based on the related art.

What is claimed is:

1. A storage element comprising:
opposed sides, opposed ends, a top, and a bottom;
receptacles defined in the storage element each by an interior surface extending from the top toward the bottom;
an interior wall defined between adjacent receptacle; and
a first locking element disposed on the interior surface of at least one receptacle for selectively retaining a work element within each at least one receptacle.

2. The storage element of claim 1, further comprising a slot formed in at least one interior wall.

3. The storage element of claim 1, wherein the locking element is a taper formed in a lower portion of the receptacle.

4. The storage element of claim 3, wherein the taper is defined by a draft angle of approximately 0 degrees to 5 degrees.

5. The storage element of claim 1, wherein the interior surface is defined by a plurality of planar portions.

6. The storage element of claim 5, wherein the locking element is a taper formed in a lower portion of the receptacle on at least one of the planar portions.

7. The storage element of claim 2, wherein the slot extends from the top toward the bottom.

8. The storage element of claim 1, wherein a projection extends from at least one end.

9. The storage element of claim 1, wherein the locking element is a protrusion formed in an upper portion of at least one receptacle.

10. The storage element of claim 9, wherein the protrusion is adjacent a slot formed in at least one interior wall.

11. The storage element of claim 9, wherein the protrusion is disposed about the interior surface.

12. The storage element of claim 9, wherein the protrusion is disposed on the interior surface other than adjacent the interior wall.

13. The storage element of claim 1, wherein the locking element is a channel formed in an upper portion of at least one receptacle.

14. The storage element of claim 13, wherein the channel is adjacent a slot formed in at least one interior wall.

15. The storage element of claim 13, wherein the channel is disposed about the interior surface.

16. The storage element of claim 13, wherein the channel is disposed on the interior surface other than adjacent the interior wall.

17. The storage element of claim 1, wherein at least one of the opposed sides includes a locking portion defined adjacent the bottom.

18. The storage element of claim 17, wherein the locking portion is defined by a taper having a draft angle of approximately 0 degrees to 5 degrees.

19. The storage element of claim 1, wherein the bottom includes an outer surface having a textured surface.

20. The storage element of claim 1, further comprising a second locking element disposed in at least one receptacle for selectively retaining the work element within each at least on receptacle.

21. The storage element of claim 20, wherein the second storage element is disposed on a floor defined in the receptacle.

22. The storage element of claim 20, wherein the second storage element is selected from the group consisting of a magnet, a cut-out portion, deformable polymer, or an adhesive

23. The storage element of claim 1, wherein the work element comprises a length along a longitudinal axis less than 1.25 inches; a center portion including an outer surface having a drive contour defined thereon; and an engaging portion formed at opposing ends of the center portion.

24. The storage element of claim 23, wherein the length is no more than 1.00 inches.

25. The storage element of claim 23, wherein the drive contour is complementary to the interior surface.

26. The storage element of claim 23, wherein a channel is defined in the center portion.

27. The storage element of claim 26, wherein the channel extends around the center portion.

28. The storage element of claim 26, wherein the channel is formed in at least one of a plurality of planar surfaces that define the drive contour.

29. The storage element of claim 23, wherein a protrusion is defined in the center portion.

30. The storage element of claim 29, wherein the protrusion extends around the center portion.

31. The storage element of claim 26, wherein the protrusion is formed in at least one of a plurality of planar surfaces that define the drive contour.

32. The storage element of claim 16, wherein each engaging portion has a different configuration.

33. The storage element of claim 1, wherein the locking element is a channel formed in an lower portion of at least one receptacle.

34. The storage element of claim 1, wherein the opposed sides include a series of notches.

35. The storage element of claim 1, wherein the locking element is a tab.

36. A method of using a storage element with a plurality of tools comprising:
providing the storage element comprising opposed sides, opposed ends, a top, and a bottom; receptacles defined in the storage element and a work element disposed in at least one of the receptacles;
providing the plurality of tools, each tool including an opening configured to complementarily engage the storage element;
installing the storage element in the opening of one tool;
removing the storage element from the opening of the one tool;
installing the storage element in the opening of another of the plurality of tools.

37. The method of claim 36, wherein the storage element is press fit into each opening.

38. The method of claim 36, wherein the storage element includes a locking portion disposed on at least one of the opposed sides.

39. The method of claim 38, further comprising engaging the locking portion when installing the storage element.

40. The method of claim 38, further comprising disengaging the locking portion when removing the storage element.

41. The method of claim 38, wherein the locking portion includes a taper disposed on at least one of the opposed sides adjacent the bottom so that the storage element is press fit into each opening.

42. The method of claim 38, wherein the locking portion includes a projection disposed on at least one of the opposed ends so that the storage element is press fit into each opening.

43. A work element comprising:
a length along a longitudinal axis less than 1.25 inches;
a center portion including a surface having a drive contour; and
an engaging portion formed at opposing ends of the center portion.

44. The work element of claim 43, wherein the length is no more than 1.00 inches.

45. The work element of claim 43, wherein the drive contour is selected from the group consisting of a plurality of planar surfaces, a plurality of alternating peaks and valleys, a plurality of alternating grooves and ridges, a plurality of alternating male and female elements, a plurality of splines and a cylindrical surface.

46. The work element of claim 43, wherein a channel is defined in the center portion.

47. The work element of claim 46, wherein the channel extends around the center portion.

48. The work element of claim 46, wherein the channel is formed in at least one of a plurality of planar surfaces that define the drive contour.

49. The work element of claim 43, wherein a protrusion is defined in the center portion.

50. The work element of claim 49, wherein the protrusion extends around the center portion.

51. The work element of claim 49, wherein the protrusion is formed in at least one of a plurality of planar surfaces that define the drive contour.

52. The work element of claim 43, wherein each engaging portion has a different configuration.
